(19) United States
(12) Patent Application Publication
(10) Pub. No.: US 2026/0011824 A1
(43) Pub. Date: Jan. 8, 2026

(54) AIR BATTERY AND SULFUR BATTERY

(71) Applicant: JAPAN SCIENCE AND TECHNOLOGY AGENCY, Kawaguchi-shi (JP)

(72) Inventors: Ryoichi TATARA, Yokohama-shi (JP); Shinichi Komaba, Tokyo (JP); Tomooki Hosaka, Tokyo (JP); Daisuke Igarashi, Tokyo (JP); Ryusei Fujimoto, Tokyo (JP)

(21) Appl. No.: 19/324,862

(22) Filed: Sep. 10, 2025

Related U.S. Application Data
(63) Continuation of application No. PCT/JP2024/009623, filed on Mar. 12, 2024.

(30) Foreign Application Priority Data
Mar. 13, 2023 (JP) 2023-039116

(51) Int. Cl. H01M 12/02; H01M 4/58; H01M 4/587; H01M 10/0569; H01M 12/08

(52) U.S. Cl. CPC H01M 12/02; H01M 4/5815; H01M 4/587; H01M 10/0569; H01M 12/08; H01M 2300/0028

(57) ABSTRACT

This air battery includes a positive electrode, a negative electrode containing an alkali metal ion, and an electrolytic solution containing an alkali metal salt, in which both a first alkali metal forming the alkali metal ion and a second alkali metal forming the alkali metal salt are independently rubidium or cesium.

### CROSS-REFERENCE TO RELATED APPLICATION

This application is a Continuation of International Application No. PCT/JP2024/009623, filed Mar. 12, 2024, which claims priority to Japanese Patent Application No. 2023-039116 filed Mar. 13, 2023. Each of the above applications is hereby expressly incorporated by reference, in its entirety, into the present application.

### TECHNICAL FIELD

The present disclosure relates to an air battery and a sulfur battery.

### BACKGROUND ART

Metal-air batteries use air (oxygen) as an energy source and can achieve a high energy density, and therefore are expected to be next-generation batteries.

Metal sulfur batteries are also expected to be next-generation batteries because sulfur-based compounds used in positive electrodes are low in cost.

Among air batteries using alkali metal ions, many lithium air batteries, sodium air batteries, and potassium air batteries have already been reported.

For example, Patent Document 1 describes a lithium-air battery including a negative electrode capable of storing and releasing lithium ions, a positive electrode configured to use oxygen in air as a positive electrode active material, and an electrolyte interposed between the negative electrode and the positive electrode, in which the electrolyte contains ether and a specific compound.

Patent Document 2 describes an alkali metal-sulfur-based secondary battery including: a positive electrode or a negative electrode having a sulfur-based electrode active material containing at least one selected from the group consisting of elemental sulfur, a metal sulfide, a metal polysulfide, and an organic sulfur compound; an electrolytic solution containing glyme and an alkali metal salt, at least a part of the glyme and the alkali metal salt forming a complex; and a counter electrode to the positive electrode or the negative electrode, the counter electrode containing an alkali metal, an alloy containing an alkali metal, or carbon, in which a mixing ratio of the alkali metal salt to the glyme is from 0.50 to a value determined by a saturation concentration of the alkali metal salt in the glyme, on a molar basis. It is described that the negative electrode contains one or more negative electrode active materials selected from the group consisting of lithium, sodium, a lithium alloy, a sodium alloy, and a composite of lithium/inert sulfur.

### CITATION LIST

### Patent Documents

Patent Document 1: Japanese Patent Application Laid-Open (JP-A) No. 2020-198149
Patent Document 2: Japanese Patent Application Laid-Open (JP-A) No. 2012-109223

### SUMMARY OF INVENTION

### Technical Problem

In air batteries, further improvement of charge-discharge cycle characteristics has been required.

An object to be achieved by an embodiment according to the disclosure is to provide an air battery having excellent charge-discharge cycle characteristics.

An object to be achieved by an embodiment according to the disclosure is to provide a sulfur battery having excellent charge-discharge cycle characteristics.

### Solution to Problem

The disclosure includes the following aspects.

<1>

An air battery including: a positive electrode; a negative electrode containing an alkali metal ion; and an electrolytic solution containing an alkali metal salt, in which both a first alkali metal forming the alkali metal ion and a second alkali metal forming the alkali metal salt are independently rubidium or cesium.

<2>

The air battery according to <1>, in which the alkali metal salt is a salt of the second alkali metal and at least one selected from the group consisting of bis(fluorosulfonyl)imide, bis(trifluoromethanesulfonyl)imide, bis(pentafluoroethanesulfonyl)imide, (fluorosulfonyl) (trifluoromethylsulfonyl)imide, and perchloric acid.

<3>

The air battery according to <1> or <2>, in which the electrolytic solution further contains ether as a solvent.

<4>

The air battery according to <3>, in which the ether is at least one selected from the group consisting of triethylene glycol dimethyl ether, tetraethylene glycol dimethyl ether, and pentaethylene glycol dimethyl ether.

<5>

The air battery according to any one of <1> to <4>, in which the negative electrode is a carbon material doped with the alkali metal ion.

<6>

The air battery according to any one of <1> to <5>, in which a concentration of the alkali metal salt in the electrolytic solution is 2 mol/kg or more.

<7>

A sulfur battery including: a positive electrode containing at least one of elemental sulfur or a sulfur compound; a negative electrode containing an alkali metal ion; and an electrolytic solution containing an alkali metal salt, in which
both a first alkali metal forming the alkali metal ion and a second alkali metal forming the alkali metal salt are independently rubidium or cesium.
   <8>

The sulfur battery according to <7>, in which the alkali metal salt is a salt of the second alkali metal and at least one selected from the group consisting of bis(fluorosulfonyl)imide, bis(trifluoromethanesulfonyl)imide, bis(pentafluoroethanesulfonyl)imide, (fluorosulfonyl) (trifluoromethylsulfonyl)imide, and perchloric acid.

<9>

The sulfur battery according to <7> or <8>, in which the electrolytic solution further contains ether as a solvent.

<10>

The sulfur battery according to <9>, in which the ether is at least one selected from the group consisting of triethylene glycol dimethyl ether, tetraethylene glycol dimethyl ether, and pentaethylene glycol dimethyl ether.

<11>

The sulfur battery according to any one of <7> to <10>, in which the negative electrode is a carbon material doped with the alkali metal ion.

<12>

The sulfur battery according to any one of <7> to <11>, in which a concentration of the alkali metal salt in the electrolytic solution is 2 mol/kg or more.

### Advantageous Effects of Invention

According to an embodiment according to the disclosure, an air battery having excellent charge-discharge cycle characteristics is provided.

According to another embodiment according to the disclosure, a sulfur battery having excellent charge-discharge cycle characteristics is also provided.

### BRIEF DESCRIPTION OF DRAWINGS

FIG. 1 is a schematic view showing an example of a cell configuration in an air battery according to the disclosure.

FIG. 2 is a schematic view showing an example of a cell configuration in a sulfur battery according to the disclosure.

FIG. 3 is a cross-sectional view of an air battery cell for measurement.

FIG. 4 is a graph showing charge-discharge test results of a first cycle in a half-cell test of a positive electrode.

FIG. 5 is a graph showing results of the change in a charge capacity up to the 50th cycle in a half-cell test of a positive electrode.

FIG. 6 is a graph showing results of the change in a charge capacity up to the 50th cycle in a half-cell test of a positive electrode.

FIG. 7 is a graph showing charge-discharge curves up to the 5th cycle of an air battery prepared using rubidium as an alkali metal.

FIG. 8 is a cross-sectional view of a sulfur battery cell for measurement.

FIG. 9 is a graph showing charge-discharge test results in a case in which a solution R1 is used as an electrolytic solution.

FIG. 10 is a graph showing charge-discharge test results in a case in which a solution C1 is used as an electrolytic solution.

FIG. 11 is a graph showing charge-discharge test results in a case in which a solution R2 is used as an electrolytic solution.

FIG. 12 is a graph showing charge-discharge test results in a case in which a solution C2 is used as an electrolytic solution.

### DESCRIPTION OF EMBODIMENTS

An embodiment of the disclosure will be described below in detail. The disclosure is not limited to the following embodiments at all. The following embodiments may be appropriately modified within the scope of the object of the disclosure.

In the disclosure, a numerical range expressed using “to” means a range including the numerical values stated before and after “to” as the lower limit value and upper limit value.

In numerical ranges described stepwise in the disclosure, an upper limit value stated in one numerical range may be replaced with an upper limit value of another numerical range stated stepwise, and a lower limit value stated in a certain numerical range may be replaced with a lower limit value of another numerical range stated stepwise. In numerical ranges described stepwise in the disclosure, an upper limit value or a lower limit value stated in a certain numerical range may be replaced with a value shown in examples.

In the disclosure, the term “step” includes not only an independent step but also a step that cannot be clearly distinguished from other steps in a case in which an intended purpose is achieved.

In the disclosure, in a case where plural kinds of substances corresponding to each component are present in a composition, a content of each component in the composition means a total amount of the plural kinds of substances present in the composition, unless otherwise specified.

In the disclosure, a combination of preferable aspects is a more preferable aspect.

### [Air Battery]

An air battery according to the disclosure includes a positive electrode, a negative electrode containing an alkali metal ion, and an electrolytic solution containing an alkali metal salt, in which both a first alkali metal forming the alkali metal ion and a second alkali metal forming the alkali metal salt are independently rubidium or cesium.

Conventionally, in research and development of an alkaline air battery, research has been conducted mainly on lithium capable of increasing an energy density per mass, as well as on sodium and potassium. There were no published experimental results on rubidium or cesium. The present inventors have found that when rubidium or cesium is used as an alkali metal ion contained in a negative electrode and an alkali metal forming an alkali metal salt contained in an electrolytic solution, charge-discharge cycle characteristics are significantly improved as compared with the case of using sodium and potassium.

The reason for this is not clear, but is presumed as follows.

It is known that a discharge product of an air battery is AO₂ (A⁺: alkali metal ion, O₂⁻: superoxide ion). The ionic radius of the superoxide ion is 1.49 Å, whereas the ionic radius of the lithium ion is 0.76 Å, the ionic radius of the sodium ion is 1.02 Å, the ionic radius of the potassium ion is 1.38 Å, the ionic radius of the rubidium ion is 1.52 Å, and the ionic radius of the cesium ion is 1.67 Å. Since the ionic radii of the rubidium ion and the cesium ion are about the same as the ionic radius of the superoxide ion, it is presumed that the discharge products are stable, and thus the discharge cycle characteristics are excellent.

Hereinafter, each element included in the air battery will be described in detail.

### <Electrolytic Solution>

The air battery according to the disclosure includes an electrolytic solution. The electrolytic solution contains an alkali metal salt.

### (Alkali Metal Salt)

The alkali metal forming the alkali metal salt contained in the electrolytic solution is rubidium or cesium, and is preferably rubidium.

From the viewpoint of stability in the presence of a superoxide, the alkali metal salt is preferably a salt of an alkali metal and at least one selected from the group consisting of bis(fluorosulfonyl)imide, bis(trifluoromethanesulfonyl)imide, bis(pentafluoroethanesulfonyl)imide, (fluorosulfonyl) (trifluoromethylsulfonyl)imide, and perchloric acid.

A concentration of the alkali metal salt in the electrolytic solution is not particularly limited, and is preferably 2 mol/kg or more, and more preferably 3.7 mol/kg or more, from the viewpoint of stability of the negative electrode. An upper limit of the concentration is, for example, 12 mol/kg.

In particular, in a case where the negative electrode contains graphite as the negative electrode active material, the concentration of the alkali metal salt in the electrolytic solution is preferably high in order to favorably operate the battery. Specifically, the concentration of the alkali metal salt in the electrolytic solution is preferably 2 mol/kg or more, and more preferably 3.7 mol/kg or more.

### (Solvent)

The electrolytic solution preferably contains a solvent in addition to the alkali metal salt.

Examples of the solvent include ether, nitrile, sulfone, and sulfoxide.

Among them, the solvent is preferably ether from the viewpoint of reduction stability.

Examples of the ether include dimethoxyethane, diethylene glycol dimethyl ether, triethylene glycol dimethyl ether, tetraethylene glycol dimethyl ether, and pentaethylene glycol dimethyl ether.

Among them, the ether is preferably at least one selected from the group consisting of triethylene glycol dimethyl ether, tetraethylene glycol dimethyl ether, and pentaethylene glycol dimethyl ether, from the viewpoint of a high boiling point and difficulty in evaporation.

### (Other Components)

The electrolytic solution may contain other components in addition to the alkali metal salt and the solvent, if necessary.

As other components, known additives can be used, and examples thereof include alkali metal nitrates and fluoroethylene carbonate.

Examples of other components include an overcharge inhibitor, a dehydrating agent, and an oxygen scavenger.

### <Negative Electrode>

The air battery according to the disclosure includes a negative electrode. The negative electrode contains an alkali metal ion.

The alkali metal forming the alkali metal ion contained in the negative electrode is rubidium or cesium, and is preferably rubidium.

In a case in which the alkali metal forming the alkali metal salt contained in the electrolytic solution is rubidium, the alkali metal forming the alkali metal ion contained in the negative electrode is also rubidium. Similarly, in a case in which the alkali metal forming the alkali metal salt contained in the electrolytic solution is cesium, the alkali metal forming the alkali metal ion contained in the negative electrode is also cesium.

The negative electrode preferably contains a negative electrode active material in addition to an alkali metal ion.

The negative electrode active material is not particularly limited as long as it is a material into which alkali metal ions can be inserted, and examples thereof include carbon materials such as graphite, cokes, hard carbon, carbon black, pyrolytic carbons, carbon fibers, and carbonized organic polymer compounds and KTi₂(PO₄)₃, P, Sn, Sb, and MXene (heterostructured atomic layered materials. The shape of the carbon material may be, for example, any of a flaky shape such as natural graphite, a spherical shape such as mesocarbon microbeads, a fibrous shape such as graphitized carbon fiber, or a particulate aggregate.

Among them, the negative electrode active material is preferably a carbon material doped with an alkali metal ion, and more preferably graphite doped with an alkali metal ion.

The graphite refers to a graphite-based carbon material.

Examples of the graphite-based carbon material include natural graphite, artificial graphite, and expandable graphite. As the natural graphite, for example, flake graphite or massive graphite can be used. As the artificial graphite, for example, massive graphite, vapor phase growth graphite, flake graphite, or fibrous graphite can be used. Among them, flake graphite or massive graphite is preferable for reasons such as high packing density. Two or more kinds of graphite may be used in combination.

An upper limit value of an average particle size of graphite is preferably 30 μm, more preferably 15 μm, and still more preferably 10 μm, and a lower limit value is preferably 0.5 μm, more preferably 1 μm, and still more preferably 2 μm. The average particle size of graphite is a value measured by an electron microscope observation method.

Examples of the graphite include those having a plane spacing d(002) of 3.354 Å to 3.370 Å (Angstrom, 1 Å=0.1 nm) and a crystallite size Lc of 150 Å or more.

The negative electrode may contain a known additive used for preparing a negative electrode of a battery. Examples of the additive include a binder and conductive carbon.

The binder is not particularly limited, and a known binder can be used, and examples thereof include a polymer compound. Specific examples of the polymer compound include a fluororesin, a polyolefin resin, a rubber-like polymer, polyamide, polyimide, polyamideimide, polyglutamic acid starch, a cellulose-based compound, polyacrylic acid, sodium polyacrylate, and polyacrylonitrile.

Examples of the fluororesin include polyvinylidene fluoride (PVDF), vinylidene fluoride-hexafluoropropylene fluorine rubber (VDF-HFP fluorine rubber), and vinylidene fluoride-hexafluoropropylene-tetrafluoroethylene fluorine rubber (VDF-HFP-TFE fluorine rubber).

Examples of the polyolefin resin include polyethylene, syndiotactic-1,2-polybutadiene, an ethylene-vinyl acetate copolymer, and a propylene-α-olefin (2 to 12 carbon atoms) copolymer.

Examples of the rubber-like polymer include a styrene-butadiene rubber, an isoprene rubber, a butadiene rubber, an ethylene-propylene rubber, a styrene-butadiene-styrene block copolymer and a hydrogenated product thereof, a styrene-ethylene-butadiene-styrene copolymer, and a styrene-isoprene-styrene block copolymer, and a hydrogenated product thereof.

Examples of the cellulose-based compound include cellulose, methyl cellulose, carboxymethyl cellulose, hydroxymethyl cellulose, hydroxyethyl cellulose, hydroxypropyl cellulose, carboxymethyl hydroxyethyl cellulose, and nitrocellulose.

Among them, the binder is preferably a cellulose-based compound and more preferably carboxymethyl cellulose from the viewpoint of surface protection by coating. The carboxymethyl cellulose may be in the form of a salt.

In the negative electrode, a content of the binder is preferably from 1% by mass to 20% by mass with respect to a total content of the binder and the negative electrode active material.

The shape and size of the negative electrode are not particularly limited, and can be set to a desired shape and size according to the shape and size of a battery to be used.

### <Positive Electrode>

The air battery according to the disclosure includes a positive electrode.

In the positive electrode, oxygen from a gas is used as a positive electrode active material. The gas may be air which is a gas containing oxygen, or may be oxygen gas.

The positive electrode preferably contains a material capable of oxidation-reduction of oxygen. Examples of such a material include Ketjen black; carbon black such as acetylene black; carbonaceous material such as carbon nanotubes; and conductive polymers such as polythiazyl and polyacetylene.

The positive electrode may contain a known additive used for preparing a positive electrode of a battery. Examples of the additive include a binder and conductive carbon.

Examples of the binder include the same binders as those optionally contained in the negative electrode.

Among them, the binder is preferably a fluororesin from the viewpoint of stability against superoxides.

The shape and size of the positive electrode are not particularly limited, and can be set to a desired shape and size according to the shape and size of a battery to be used.

### <Separator>

The air battery according to the disclosure preferably includes a separator.

The separator plays a role of physically isolating the positive electrode and the negative electrode to prevent internal short circuit.

The separator is made of a porous material, and voids thereof are impregnated with an electrolytic solution and have ion permeability in order to secure a battery reaction.

Examples of the separator include a resin porous membrane and a nonwoven fabric. The separator may be a single layer including a layer of a porous membrane or a layer of a nonwoven fabric, or may be a laminate including a plurality of layers. Examples of the laminate include a laminate having a plurality of porous membrane layers having different compositions, and a laminate having a porous membrane layer and a nonwoven fabric layer.

A material of the separator can be selected in consideration of conditions such as operating temperature of a battery and a composition of an electrolytic solution. Examples of the resin contained in the fibers that form the porous film and the nonwoven fabric include polyolefin resins such as polyethylene, polypropylene, and an ethylene-propylene copolymer; polyphenylene sulfide resin such as polyphenylene sulfide and polyphenylene sulfide ketone; polyamide resin such as aromatic polyamide resin; and a polyimide resin. These resin may be used singly, or in combination of two or more kinds thereof. The fiber forming the nonwoven fabric may be an inorganic fiber such as a glass fiber.

The shape and size of the separator are not particularly limited, and can be set to a desired shape and size according to the shape and size of a battery to be used.

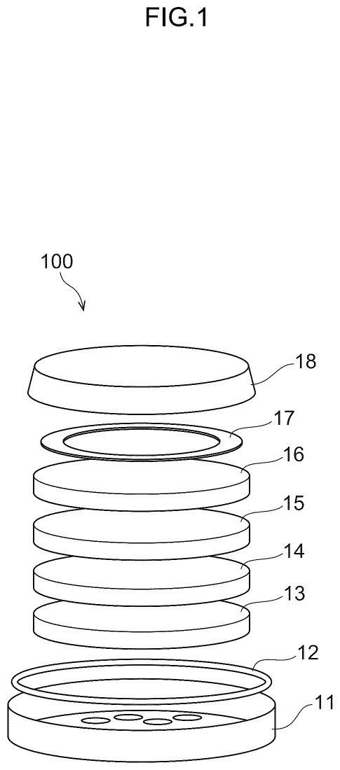

FIG. 1 is a schematic diagram illustrating an example of a configuration of an air battery 100 according to the present disclosure. The air battery according to the disclosure is not limited thereto. The air battery 100 shown in FIG. 1 is a coin-type battery, and includes a battery case 11 with an air hole, a gasket 12, a positive electrode 13, a separator 14, a negative electrode 15, a spacer 16, a spring 17, and a battery case 18. The separator 14 is impregnated with an electrolytic solution (not shown).

The battery case 11 with an air hole is electrically connected to the positive electrode 13, the battery case 18 is electrically connected to the negative electrode 15 via the spacer 16, and the battery case 11 with an air hole and the battery case 18 are electrically insulated by the gasket 12.

### [Sulfur Battery]

A sulfur battery according to the disclosure includes a positive electrode containing at least one of elemental sulfur or a sulfur compound; a negative electrode containing an alkali metal ion; and an electrolytic solution containing an alkali metal salt, in which both a first alkali metal forming the alkali metal ion and a second alkali metal forming the alkali metal salt are independently rubidium or cesium.

Hereinafter, each element included in the sulfur battery will be described in detail.

### <Electrolytic Solution>

The sulfur battery according to the disclosure includes an electrolytic solution. The electrolytic solution contains an alkali metal salt.

A preferred embodiment of the electrolytic solution contained in the sulfur battery is the same as the preferred embodiment of the electrolytic solution contained in the air battery.

### <Negative Electrode>

A sulfur battery according to the disclosure includes a negative electrode. The negative electrode contains an alkali metal ion.

A preferred embodiment of the negative electrode contained in the sulfur battery is the same as the preferred embodiment of the negative electrode contained in the air battery.

### <Positive Electrode>

A sulfur battery according to the disclosure includes a positive electrode.

The positive electrode contains at least one of elemental sulfur or a sulfur compound.

The sulfur compound is not particularly limited as long as it is a sulfur-containing compound, and examples thereof include sulfurized polyacrylonitrile and metal sulfides.

The positive electrode preferably contains a material capable of oxidation-reduction of sulfur. Examples of such a material include Ketjen black; carbon black such as acetylene black; carbonaceous material such as carbon nanotubes; and conductive polymers such as polythiazyl and polyacetylene.

The positive electrode may contain a known additive used for preparing a positive electrode of a battery. Examples of the additive include a binder and conductive carbon.

Examples of the binder include the same binders as those described above.

Among them, the binder is preferably a cellulose-based compound from the viewpoint of binding property.

The shape and size of the positive electrode are not particularly limited, and can be set to a desired shape and size according to the shape and size of a battery to be used.

### <Separator>

The sulfur battery according to the disclosure preferably includes a separator.

A preferred embodiment of the separator contained in the sulfur battery is the same as the preferred embodiment of the separator contained in the air battery.

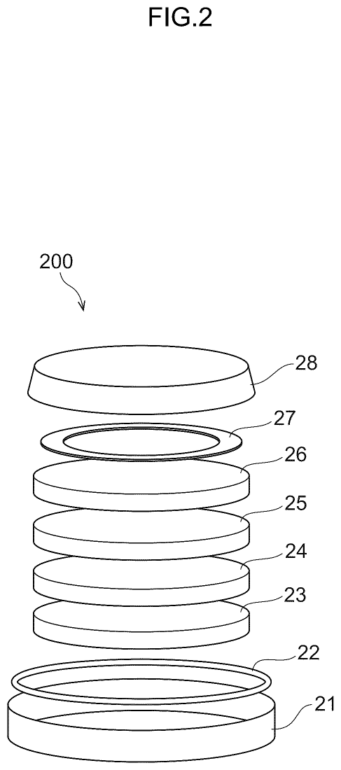

FIG. 2 is a schematic view showing an example of a configuration of sulfur battery 200 according to the disclosure. The sulfur battery according to the disclosure is not limited thereto. A sulfur battery 200 shown in FIG. 2 is a coin-type battery, and includes a battery case 21 on a negative electrode side, a gasket 22, a negative electrode 23, a separator 24, a positive electrode 25, a spacer 26, a spring 27, and a battery case 28 on a positive electrode side. The separator 24 is impregnated with an electrolytic solution (not shown).

### EXAMPLES

Hereinafter, the disclosure will be described more specifically with reference to examples. For example, materials, using amounts, proportions, processing details, and processing procedures shown in the following examples can be appropriately changed without departing from the gist of the disclosure. Therefore, the scope of the disclosure is not limited to the following specific examples.

### [Air Battery]

### <Preparation of Air Battery (Half-Cell) for Measurement>

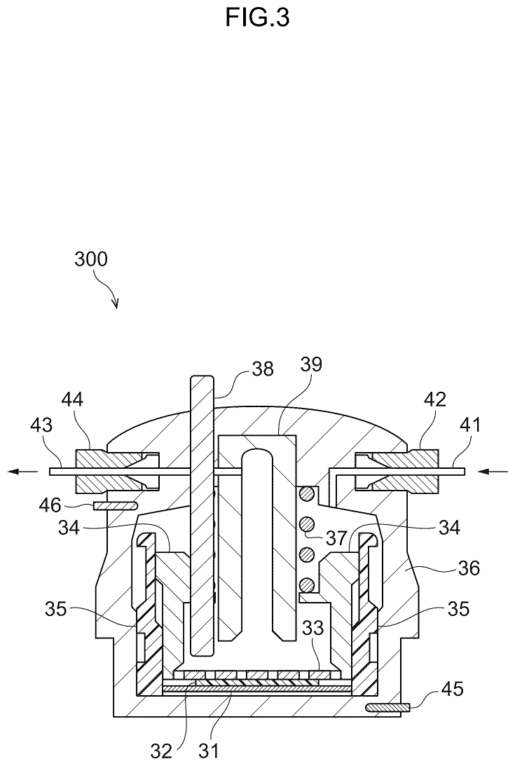

An air battery for measurement having the structure shown in FIG. 3 was produced. FIG. 3 is a cross-sectional view of an air battery cell for measurement.

In the air battery cell 300 for measurement shown in FIG. 3, the counter electrode 31 and a working electrode 33 are arranged to face each other with the separator 32 interposed therebetween. The separator 32 is impregnated with an electrolytic solution (not shown). An electrode guide 34 is provided on the working electrode 33 in order to fix the working electrode 33 so as not to shift the position thereof. The counter electrode 31 and the working electrode 33 are sandwiched by a cell body 35 to prevent short circuit. An exterior material 36 is provided outside the cell body.

A reference electrode 38 is inserted inside the air battery cell 300 for measurement. The counter electrode 31, the separator 32, and the working electrode 33 are pressed by an electrode holder 39. A spring 37 has a role of pressurizing the electrode holder 39.

An exterior material 36 is provided with a gas pipe joint 42, and air is sent to the inside of the air battery cell 300 via an air sending pipe 41.

The exterior material 36 is provided with a gas pipe joint 44, and air is exhausted from the inside of the air battery cell 300 through an air delivery pipe 43.

A counter electrode terminal 45 and a working electrode terminal 46 are terminals connected to the potentiostat.

In this example, the battery characteristics were evaluated as a half-cell. The electrode, the electrolytic solution, and the charge-discharge conditions are as follows.

### (Electrode)

Working electrode . . . Ketjen black:Polytetrafluoroethylene=80:20 (mass ratio) was dispersed in N-methylpyrrolidone, and applied on a 15 mmφ carbon paper (porous gas diffusion substrate) so that the amount of Ketjen black per unit area was 1.25 mg/cm².
Reference electrode . . . An Ag wire was immersed in a 50 mmol/L silver trifluoromethanesulfonate solution in triethylene glycol dimethyl ether.
Counter electrode . . . Activated carbon:Ketjen black:Polytetrafluoroethylene=80:10:10 (mass ratio) are dispersed in N-methylpyrrolidone, and applied to an aluminum foil.
Separator . . . Glass filter (Product name “GB-100R”, manufactured by ADVANTEC Corporation)
Lamination direction: Lamination is performed such that the active material applied surfaces of the working electrode and the counter electrode face each other with the separator interposed therebetween.

### (Electrolytic Solution)

1 mol/L LiTFSI solution in triethylene glycol dimethyl ether
1 mol/L NaTFSI solution in triethylene glycol dimethyl ether
1 mol/L KTFSI solution in triethylene glycol dimethyl ether
1 mol/L RbTFSI solution in triethylene glycol dimethyl ether
1 mol/L CsTFSI solution in triethylene glycol dimethyl ether
   TFSI means bis(trifluoromethanesulfonyl)imide.

### (Charge-Discharge Conditions)

Discharge: 1 hour discharge or lower limit potential −1.9 V vs Ag/Ag⁺
Charge: Upper limit potential 0.6 V (electrolytic solution: NaTFSI), 0.2 V (electrolytic solution: KTFSI), 0.1 V (Electrolytic solution: RbTFSI, CsTFSI) vs Ag/Ag⁺
Current density: 0.5 mA (0.283 mAcm⁻²)
Cell: Pure oxygen purged three-electrode cell
Temperature: 25° C.

The density, viscosity, and ionic conductivity of each prepared electrolytic solution were measured.

The density was measured using a density/specific gravity/concentration meter (product name “DMA 4100M”, manufactured by Anton Paar GmbH).

The viscosity was measured using a viscometer (product name “Lovis 2000ME”, manufactured by Anton Paar GmbH).

The ionic conductivity was measured using an electrical conductivity meter (product name “CM-41X”, manufactured by TOADKK Corporation).

The results are shown in Table 1.

TABLE 1

| Alkali metal | Density | Viscosity | Ionic conductivity |
|---|---|---|---|
| salt | [g cm⁻³] | [mPa · s] | [mS cm⁻¹] |
| LiTFSI | 1.16 | 7.82 | 4.2 |
| NaTFSI | 1.16 | 7.75 | 4.06 |
| KTFSI | 1.15 | 7.85 | 4.1 |
| RbTFSI | 1.2 | 7.38 | 4.54 |
| CsTFSI | 1.24 | 7.21 | 4.77 |

It was found that in a case in which the alkali metal forming the alkali metal salt is rubidium or cesium, the viscosity is low and the ionic conductivity is high as compared with the case of lithium, sodium, or potassium.

A charge-discharge test was performed using the prepared half-cell.

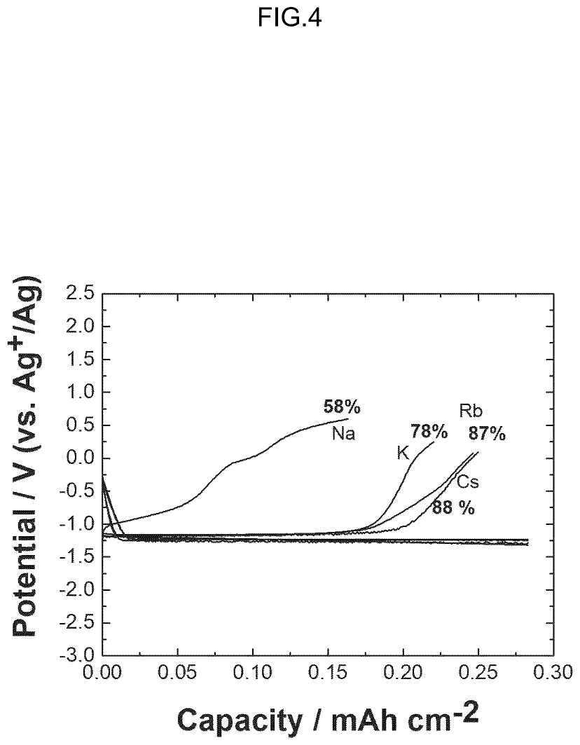

FIG. 4 is a graph showing charge-discharge test results of a first cycle in a half-cell test of a positive electrode. The numerical value (%) in FIG. 4 is the coulombic efficiency.

As shown in FIG. 4, it was found that in the electrolytic solution, in a case in which the alkali metal forming the alkali metal salt is rubidium or cesium, the coulombic efficiency in the first cycle is higher than that in the case of sodium or potassium.

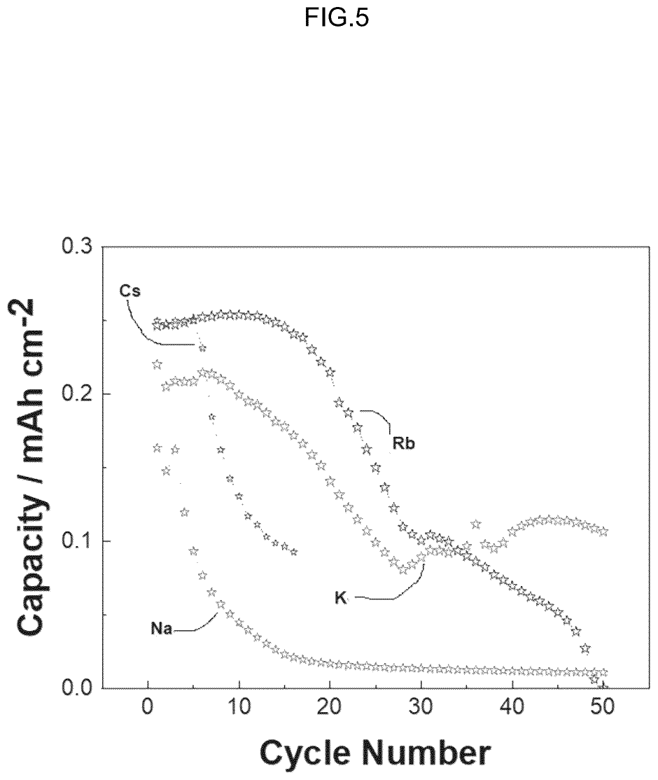

FIG. 5 is a graph showing results of the change in a charge capacity up to the 50th cycle in a half-cell test of a positive electrode.

As shown in FIG. 5, it was found that in the electrolytic solution, in a case in which the alkali metal forming the alkali metal salt is rubidium or cesium, the charge capacity up to the 5th cycle is maintained high as compared with the case of sodium or potassium.

In particular, it was found that in a case in which the alkali metal forming the alkali metal salt is rubidium, the long-term stability is excellent.

Next, a charge-discharge test was performed by changing an upper limit potential and a lower limit potential at the time of charging.

### (Charge-Discharge Conditions)

Discharge: 1 hour discharge or lower limit potential −1.5 V vs Ag/Ag⁺
Charge: Upper limit potential −0.8 V vs Ag/Ag⁺
Current density: 0.5 mA (0.283 mAcm⁻²)
Cell: Pure oxygen purged three-electrode cell
Temperature: 25° C.

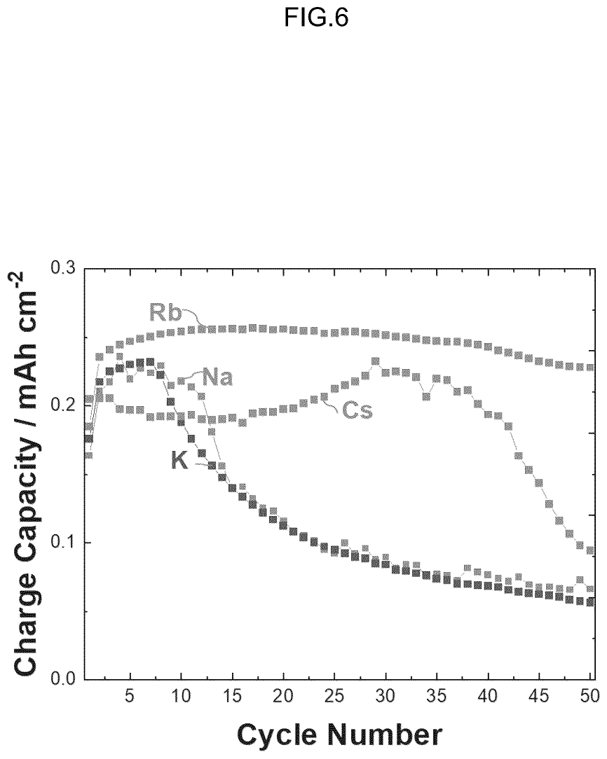

FIG. 6 is a graph showing results of the change in a charge capacity up to the 50th cycle in a half-cell test of a positive electrode.

As shown in FIG. 6, it was found that in the electrolytic solution, in a case in which the alkali metal forming the alkali metal salt is rubidium or cesium, the charge capacity up to the 40th cycle is maintained high as compared with the case of sodium or potassium.

In particular, it was found that in a case in which the alkali metal forming the alkali metal salt is rubidium, the long-term stability is excellent.

Next, an air battery was prepared.

<Preparation of Graphite Doped with Rubidium Ions>

In order to insert rubidium ions into graphite, a coin cell having the structure shown in FIG. 2 was prepared. As a counter electrode, rubidium metal was used. As a working electrode, a composite electrode prepared by mixing natural graphite: CMC (sodium carboxymethyl cellulose) binder=95:5 (mass ratio) was used. RbTFSI: Triethylene glycol dimethyl ether=1:1 (mass ratio) was used as an electrolytic solution. Charging and discharging were performed under the following conditions.
Voltage range: 0.002 to 2 V (vs. Rb⁺/Rb)
Current density: 27.9 mAg⁻¹

After the charge reaction of the second cycle, the cell was disassembled to obtain graphite doped with rubidium ions.

### <Preparation of Air Battery>

An air battery for measurement having the structure shown in FIG. 3 was produced. The working electrode in FIG. 3 was a positive electrode, and the counter electrode in FIG. 3 was a negative electrode.
Positive electrode . . . Ketjen black:Polytetrafluoroethylene=80:20 (mass ratio) are dispersed in N-methylpyrrolidone, and applied to 15 mmφ carbon paper.
Negative electrode . . . Produced graphite doped with rubidium ions
Electrolytic solution . . . 2.9 mol/L (5.6 mol/kg) RbTFSI solution in triethylene glycol dimethyl ether

A charge-discharge test was performed under the following conditions.
Voltage range: 1.0 to 3.5 V
Current value: 0.1 mA

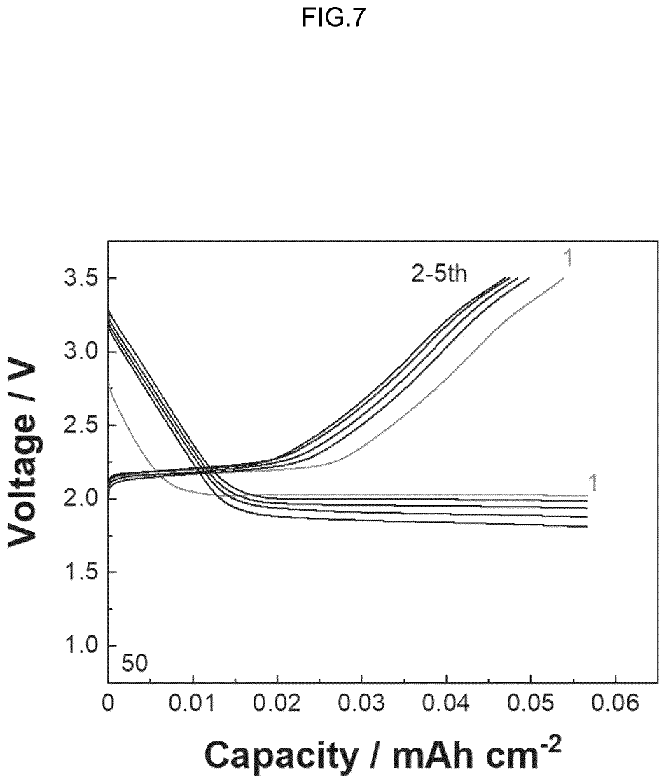

FIG. 7 is a graph showing charge-discharge curves up to the 5th cycle of an air battery prepared using rubidium as an alkali metal.

As shown in FIG. 7, in an air battery including a positive electrode, a negative electrode containing an alkali metal ion, and an electrolytic solution containing an alkali metal salt, in which both alkali metals forming the alkali metal ions and the alkali metal salt are rubidium, it has been found that RbO₂ as a discharge product is stable because the ionic radii of the rubidium ion and the superoxide ion are close to each other, and thus charge-discharge cycle characteristics are excellent. In addition, from the charge-discharge test results obtained by using a half-cell, it can be presumed that even in an air battery in which all the alkali metals forming the alkali metal salt are cesium, the charge-discharge cycle characteristics are excellent.

### [Sulfur Battery]

### <Preparation of Sulfur Battery for Measurement (Half-Cell)>

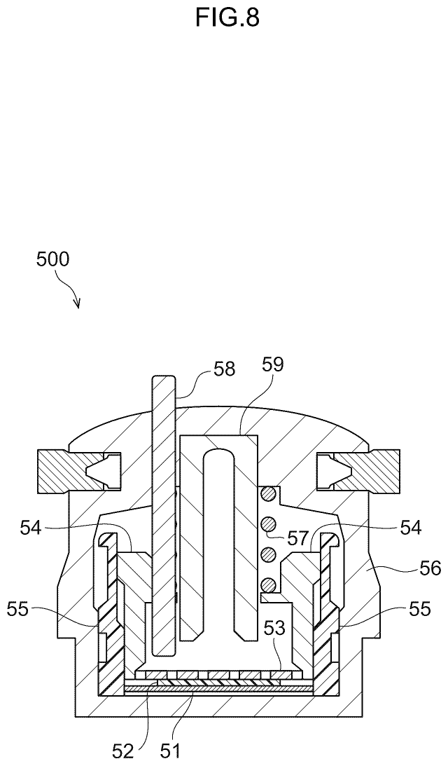

A sulfur battery for measurement having the structure shown in FIG. 8 was prepared. FIG. 8 is a cross-sectional view of a sulfur battery cell for measurement.

In a sulfur battery cell 500 for measurement shown in FIG. 8, a counter electrode 51 and a working electrode 53 are disposed to face each other with a separator 52 interposed therebetween. The separator 52 is impregnated with an electrolytic solution (not shown). An electrode guide 54 is provided on the working electrode 53 in order to fix the working electrode 53 so as not to shift the position thereof. The counter electrode 51 and the working electrode 53 are sandwiched by a cell body 55 to prevent short circuit. An exterior material 56 is provided outside the cell body.

A reference electrode 58 is inserted inside the sulfur battery cell 500 for measurement. The counter electrode 51, the separator 52, and the working electrode 53 are pressed by an electrode holder 59. A spring 57 has a role of pressurizing the electrode holder 59.

### —Preparation of Electrode Foil—

Ketjen black and elemental sulfur were mixed at a mass ratio of 67:33, and pulverized and mixed using a pestle and a mortar. A sulfur carbon composite material was prepared by a melt impregnation method in a thermostatic chamber heated to 155° C. in advance. The obtained sulfur carbon composite material and carboxymethyl cellulose (CMC) were mixed at a mass ratio of 90:10 in an ointment container using ion-exchanged water as a dispersion medium (400) μL of ion-exchanged water per 100 mg of solids (sum of sulfur-carbon composite and carboxymethyl cellulose)) to prepare a slurry. The slurry was applied onto an aluminum foil using a doctor blade and allowed to stand under atmospheric pressure for 1 day. Thereafter, the resultant was dried at 80° C. to obtain an electrode foil with a sulfur loading amount of 1.4 mg/cm².
Working electrode . . . The electrode foil punched into 15 mmφ
Reference electrode . . . Ag/Ag electrode
Counter electrode . . . Activated carbon:Ketjen black:Polytetrafluoroethylene=80:10:10 (mass ratio) are dispersed in N-methylpyrrolidone, and applied to an aluminum foil.
Separator . . . Glass filter
Lamination direction: Lamination is performed such that the active material applied surfaces of the working electrode and the counter electrode face each other with the separator interposed therebetween.

### (Electrolytic Solution)

1 mol/L RbTFSI solution R1 in triethylene glycol dimethyl ether
1 mol/L CsTFSI solution C1 in triethylene glycol dimethyl ether
5.6 mol/kg RbTFSI solution R2 in triethylene glycol dimethyl ether
5.6 mol/kg CsTFSI solution C2 in triethylene glycol dimethyl ether

### (Charge-Discharge Conditions)

Voltage range: −2.5 V to 0.1 V (vs. Ag/Ag⁺)
Current density: 167.2 mAg⁻¹)
Cell: Three-electrode cell (SB9 manufactured by EC Frontier Co., Ltd.)

A charge-discharge test was performed using the prepared half-cell.

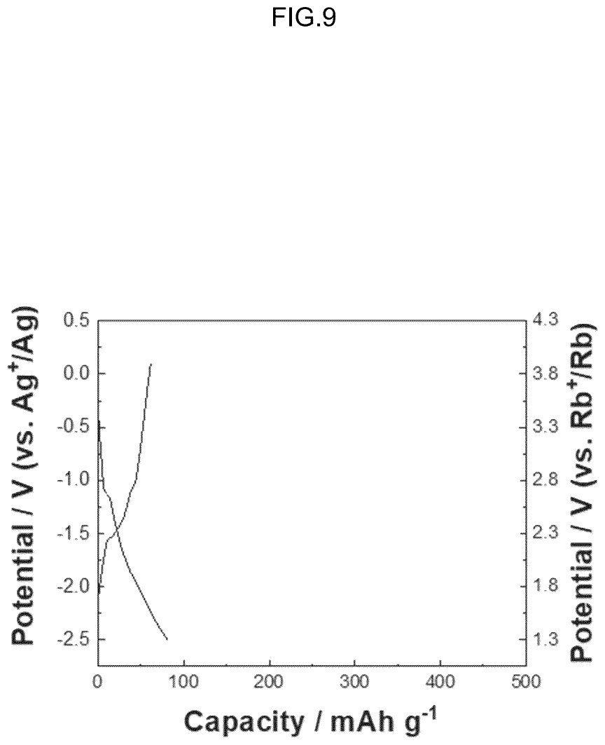

FIG. 9 is a graph showing charge-discharge test results in a case in which the solution R1 is used as an electrolytic solution.

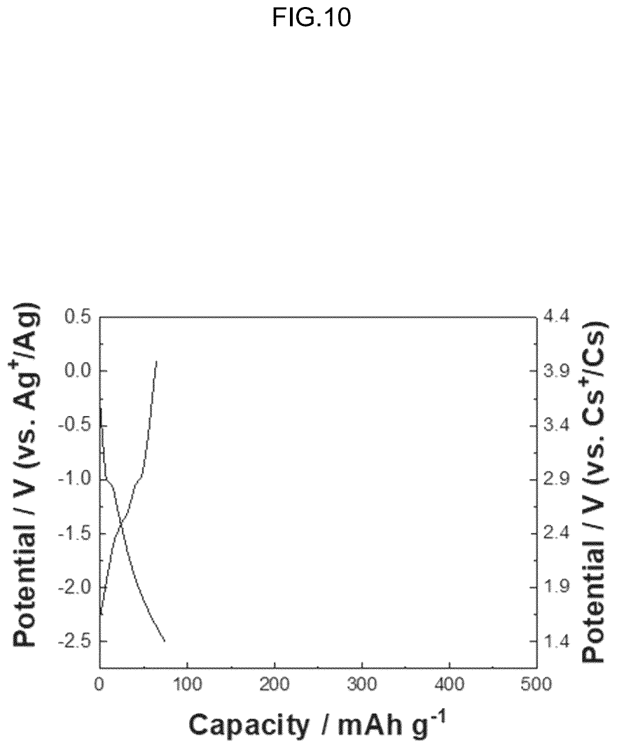

FIG. 10 is a graph showing charge-discharge test results in a case in which the solution C1 is used as an electrolytic solution.

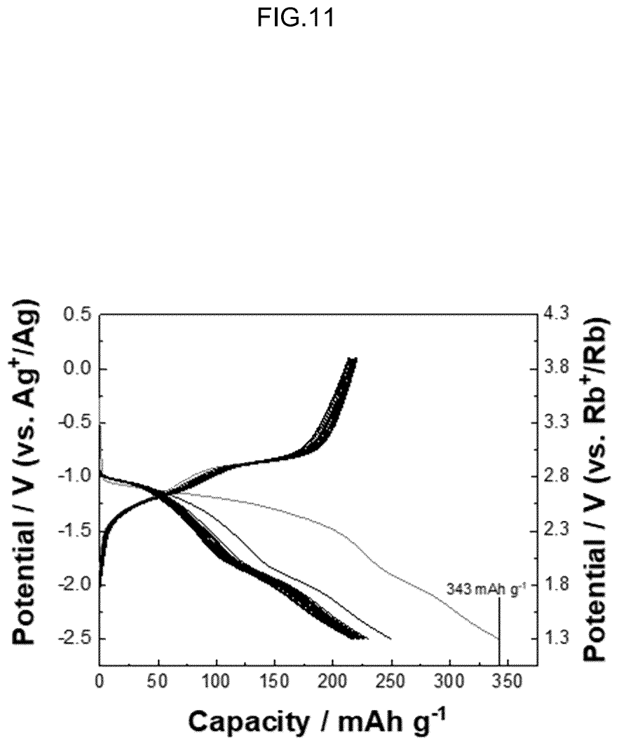

FIG. 11 is a graph showing charge-discharge test results in a case in which the solution R2 is used as an electrolytic solution.

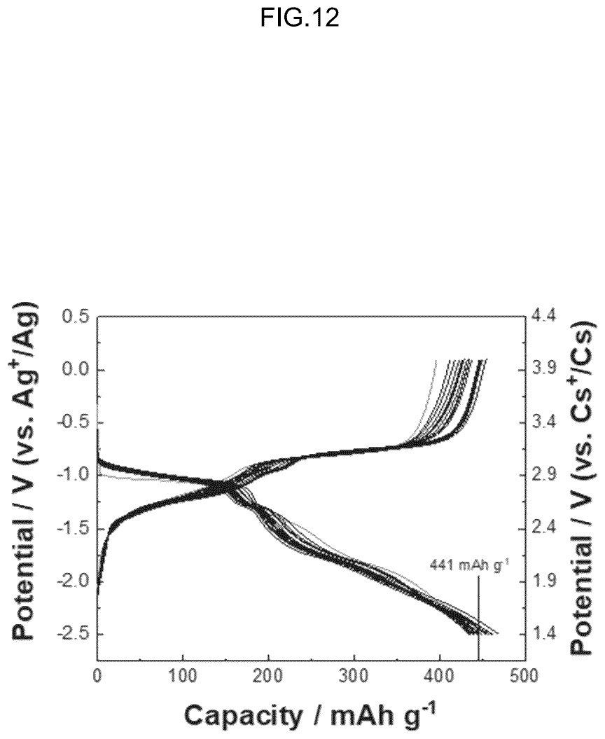

FIG. 12 is a graph showing charge-discharge test results in a case in which the solution C2 is used as an electrolytic solution.

As shown in FIGS. 9 to 12, it has been found that the sulfur battery using the electrolytic solution in which the alkali metal forming the alkali metal salt is rubidium or cesium is excellent in charge-discharge cycle characteristics.

As shown in FIG. 11, in a case in which the concentration of RbTFSI in the electrolytic solution was 5.6 mol/kg, the initial discharge capacity was 343 mAh/g. The second charge-discharge amount was reduced to 250 mAh/g, and the third and subsequent charge-discharge amounts were maintained at 200 to 250 mAh/g.

As shown in FIG. 12, in a case in which the concentration of CsTFSI in the electrolytic solution was 5.6 mol/kg, the initial discharge capacity was 441 mAh/g. The second and subsequent charge-discharge amounts were also maintained at 400 mAh/g or more.

The entire disclosure of Japanese Patent Application No. 2023-039116 filed on Mar. 13, 2023 is incorporated herein by reference. All the literature, patent application, and technical standards cited herein are also herein incorporated to the same extent as provided for specifically and severally with respect to an individual literature, patent application, and technical standard to the effect that the same should be so incorporated by reference.

1. An air battery comprising: a positive electrode; a negative electrode containing an alkali metal ion; and an electrolytic solution containing an alkali metal salt, wherein
both a first alkali metal forming the alkali metal ion and a second alkali metal forming the alkali metal salt are independently rubidium or cesium.

2. The air battery according to claim 1, wherein the alkali metal salt is a salt of the second alkali metal and at least one selected from the group consisting of bis(fluorosulfonyl)imide, bis(trifluoromethanesulfonyl)imide, bis(pentafluoroethanesulfonyl)imide, (fluorosulfonyl) (trifluoromethylsulfonyl)imide, and perchloric acid.

3. The air battery according to claim 1, wherein the electrolytic solution further contains ether as a solvent.

4. The air battery according to claim 3, wherein the ether is at least one selected from the group consisting of triethylene glycol dimethyl ether, tetraethylene glycol dimethyl ether, and pentaethylene glycol dimethyl ether.

5. The air battery according to claim 1, wherein the negative electrode is a carbon material doped with the alkali metal ion.

6. The air battery according to claim 1, wherein a concentration of the alkali metal salt in the electrolytic solution is 2 mol/kg or more.

7. A sulfur battery comprising: a positive electrode containing at least one of elemental sulfur or a sulfur compound; a negative electrode containing an alkali metal ion; and an electrolytic solution containing an alkali metal salt, wherein
both a first alkali metal forming the alkali metal ion and a second alkali metal forming the alkali metal salt are independently rubidium or cesium.

8. The sulfur battery according to claim 7, wherein the alkali metal salt is a salt of the second alkali metal and at least one selected from the group consisting of bis(fluorosulfonyl)imide, bis(trifluoromethanesulfonyl)imide, bis(pentafluoroethanesulfonyl)imide, (fluorosulfonyl) (trifluoromethylsulfonyl)imide, and perchloric acid.

9. The sulfur battery according to claim 7, wherein the electrolytic solution further contains ether as a solvent.

10. The sulfur battery according to claim 9, wherein the ether is at least one selected from the group consisting of triethylene glycol dimethyl ether, tetraethylene glycol dimethyl ether, and pentaethylene glycol dimethyl ether.

11. The sulfur battery according to claim 7, wherein the negative electrode is a carbon material doped with the alkali metal ion.

12. The sulfur battery according to claim 7, wherein a concentration of the alkali metal salt in the electrolytic solution is 2 mol/kg or more.
